(19) United States
(12) Patent Application Publication
(10) Pub. No.: US 2025/0390554 A1
(43) Pub. Date: Dec. 25, 2025

(54) SOLUTION SEARCH DEVICE AND SOLUTION SEARCH METHOD

(71) Applicant: Mitsubishi Electric Corporation, Tokyo (JP)

(72) Inventors: Tadashi ONISHI, Tokyo (JP); Mamoru DOI, Tokyo (JP)

(73) Assignee: Mitsubishi Electric Corporation, Tokyo (JP)

(21) Appl. No.: 19/308,932

(22) Filed: Aug. 25, 2025

Related U.S. Application Data
(63) Continuation of application No. PCT/JP2023/019037, filed on May 23, 2023.

(51) Int. Cl. G06F 17/18

(52) U.S. Cl. CPC G06F 17/18

(57) ABSTRACT

A solution search device includes: a setting unit to set a first desired level that is a target value for a plurality of objective functions in a multi-objective optimization problem; a first optimal solution calculating unit to calculate a first optimal solution using the first desired level set by the setting unit and a frontier that is a solution set for optimizing the plurality of objective functions; and a first optimal solution adjusting unit to receive an input of an adjustment amount for adjusting the first optimal solution from a user when receiving an instruction not to employ the first optimal solution calculated by the first optimal solution calculating unit from the user, and adjust the first optimal solution within a range of the frontier on the basis of the received adjustment amount.

### CROSS REFERENCE TO RELATED APPLICATIONS

This application is a Continuation of PCT International Application No. PCT/JP2023/019037, filed on May 23, 2023, which is hereby expressly incorporated by reference into the present application.

### TECHNICAL FIELD

The present disclosure relates to a solution search device and a solution search method.

### BACKGROUND ART

In a multi-objective optimization problem that optimizes a plurality of objective functions, it is difficult to aggregate and express all objective functions into an evaluation function such as a linear weighted sum. Therefore, in the multi-objective optimization problem, various methods for obtaining an optimal solution have been proposed. For example, Patent Literature 1 discloses a prediction control method using a satisfaction trade-off method for a multi-objective optimization problem. The satisfaction trade-off method is one of interactive multi-objective programming using a desired level, and is one of methods for formulating a multi-objective optimization problem.

In the prediction control method (hereinafter, also referred to as a “related method”) described in Patent Literature 1, an input of a desired level, which is a target value for a plurality of objective functions (controlled amounts), is accepted to set the desired level, an optimal solution close to the desired level is calculated, the optimal solution is displayed, the setting of the desired level is changed by accepting an input for changing the desired level when the optimal solution does not satisfy a predetermined standard, and these steps are repeated to determine the optimal solution that satisfies the predetermined standard.

Specifically, in the above related method, an intersection of a straight line connecting an ideal point that is a minimum value of an objective function and a first desired level set by a decision maker (operator) and a line indicating a Pareto frontier that is a trade-off set of optimal solutions is calculated as a first optimal solution. Then, if the decision maker does not satisfy the first optimal solution, the setting of the desired level is changed from the first desired level to a second desired level through trade-off analysis by sensitivity analysis, and the intersection between a straight line connecting the second desired level and the ideal point and the line indicating the Pareto frontier is calculated as a second optimal solution.

### CITATION LIST

### Patent Literatures

Patent Literature 1: JP 2010-152767 A

### SUMMARY OF INVENTION

### Technical Problem

However, in the related method, as described above, if the decision maker is not satisfied with the calculated optimal solution, the processing of changing the setting of the desired level and calculating another optimal solution on the basis of the changed desired level is repeated until the calculated optimal solution becomes satisfying, and thus there is a problem that it takes time to obtain an optimal solution that the decision maker is satisfied.

The present disclosure has been made to solve the above problems, and an object of the present disclosure is to obtain a solution search device capable of reducing a time necessary for obtaining an optimal solution that satisfies a decision maker more than in the related art.

### Solution to Problem

A solution search device according to the present disclosure includes: a processor; and a memory storing a program, upon executed by the processor, to perform a process: to set a first desired level that is a target value for a plurality of objective functions in a multi-objective optimization problem; to calculate a first optimal solution using the first desired level and a frontier that is a solution set for optimizing the plurality of objective functions; and to receive an input of an adjustment amount for adjusting the first optimal solution from a user when receiving an instruction not to employ the first optimal solution calculated from the user, and adjust the first optimal solution within a range of the frontier on a basis of the received adjustment amount.

### Advantageous Effects of Invention

According to the present disclosure, it is possible to shorten a time necessary for obtaining an optimal solution that satisfies a decision maker as compared with the related art.

### BRIEF DESCRIPTION OF DRAWINGS

FIG. 1 is a diagram illustrating a configuration example of a solution search device according to a first embodiment.

FIG. 2 is a flowchart illustrating an operation example of the solution search device according to the first embodiment.

FIG. 3 is a diagram illustrating an example of extraction of a Pareto frontier by a solution extracting unit in the first embodiment.

FIG. 4 is a diagram illustrating a calculation example of a first optimal solution in the first embodiment.

FIG. 5 is a diagram illustrating a calculation example of a second optimal solution and a second desired level in the first embodiment.

FIG. 6 is a diagram illustrating details of a calculation example of a second optimal solution and a second desired level in the first embodiment.

FIG. 7 is a diagram illustrating details of a calculation example of a first optimal solution and a second optimal solution in a case where a solution space is a three-dimensional space in the first embodiment.

FIG. 8 is a diagram illustrating details of a calculation example of a second desired level in a case where the solution space is a three-dimensional space in the first embodiment.

FIGS. 9A and 9B are diagrams illustrating an example of a hardware configuration of the solution search device according to the first embodiment.

FIG. 10 is a diagram illustrating an example of a support screen in a second embodiment.

FIG. 11 is a diagram for describing an example of efficient frontier extraction in a third embodiment.

FIG. 12 is a diagram for describing a CCR model in the third embodiment.

FIG. 13 is a diagram for describing an extended CCR model in the third embodiment.

FIG. 14 is a diagram illustrating a configuration example of a solution search device according to a fourth embodiment.

FIG. 15 is a diagram illustrating a calculation example of a desired level frontier in the fourth embodiment.

FIG. 16 is a diagram illustrating a calculation example of a second optimal solution and a second desired level in the fourth embodiment.

FIG. 17 is a diagram for describing a reference area and an extended area in a fifth embodiment.

FIG. 18 is a diagram for describing a search area in the fifth embodiment.

### DESCRIPTION OF EMBODIMENTS

Hereinafter, embodiments of the present disclosure will be described in detail with reference to the drawings.

### First Embodiment

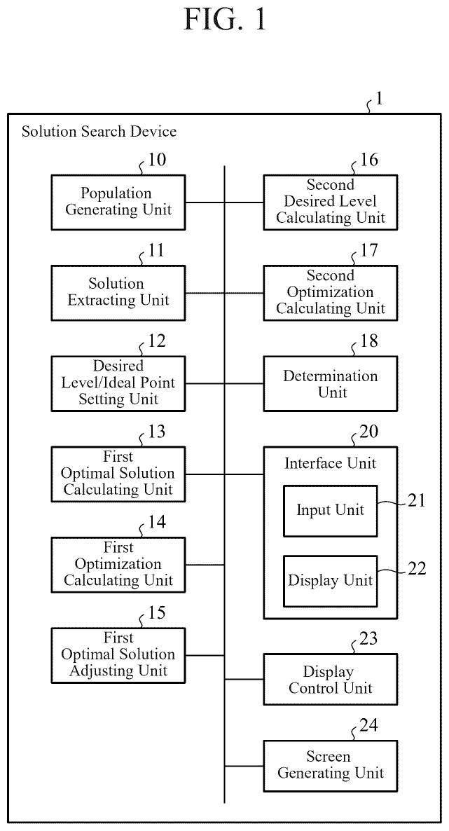

FIG. 1 is a diagram illustrating a configuration example of a solution search device 1 according to a first embodiment. For example, as illustrated in FIG. 1, the solution search device 1 includes a population generating unit 10, a solution extracting unit 11, a desired level/ideal point setting unit 12, a first optimal solution calculating unit 13, a first optimization calculating unit 14, a first optimal solution adjusting unit 15, a second desired level calculating unit 16, a second optimization calculating unit 17, a determination unit 18, an interface unit 20 (an input unit 21 and a display unit 22), a display control unit 23, and a screen generating unit 24.

The population generating unit 10 generates a set (population) of solutions in a multi-objective optimization problem that optimizes a plurality of objective functions. For example, the population generating unit 10 generates a set of solutions (population) in a space (hereinafter, also referred to as a “solution space”) defined by a plurality of objective functions, using a known optimization algorithm such as non-dominant sorting genetic algorithm 2 (NSGA-II).

The solution extracting unit 11 extracts a frontier, which is a solution set for optimizing a plurality of objective functions, from a set of solutions generated by the population generating unit 10. For example, the solution extracting unit 11 extracts a Pareto frontier from the set of solutions generated by the population generating unit 10 using a known optimization algorithm such as the NSGA-II.

The Pareto frontier is a set of Pareto solutions. A Pareto solution refers to a solution in which another objective function deteriorates when an objective function of any of a plurality of objective functions is to be optimized. The Pareto frontier is expressed by a line connecting Pareto solutions on the solution space when there are two objective functions, that is, when the solution space is a two-dimensional space. Further, when there are three objective functions, that is, when the solution space is a three-dimensional space, the Pareto frontier is expressed by a plane including the Pareto solution on the solution space.

A decision maker who is a user of the solution search device 1 inputs an ideal point and a first desired level to the solution search device 1 via the interface unit 20. The desired level/ideal point setting unit 12 receives the ideal point and first desired level input by the decision maker via the interface unit 20, and sets the received ideal point and first desired level on the solution space.

The ideal point is a point indicating an optimal solution (for example, a minimum value) in all the objective functions among the plurality of objective functions. Further, the desired level is a point indicating a criterion that is desired to be satisfied at a minimum in each objective function among the plurality of objective functions, and the first desired level is a desired level that is first input (designated) by the decision maker.

The first optimal solution calculating unit 13 calculates a first optimal solution by using the ideal point and the first desired level set by the desired level/ideal point setting unit 12 and the frontier (for example, Pareto frontier) extracted by the solution extracting unit 11.

For example, the first optimal solution calculating unit 13 specifies, in the solution space, an intersection between a straight line connecting the ideal point and the first desired level set by the desired level/ideal point setting unit 12 and a line indicating the frontier extracted by the solution extracting unit 11, and calculates the specified intersection as the first optimal solution. The first optimal solution calculated here is presented to the decision maker via the interface unit 20.

The decision maker checks the presented first optimal solution and determines the following points. Then, the decision maker inputs the determination result to the solution search device 1 via the interface unit 20.
(1) Whether or not to employ the presented first optimal solution
(2) Whether or not to optimize the first optimal solution on the basis of the first desired level when not employing the presented first optimal solution
(3) Whether or not to adjust the first optimal solution within the range of the frontier when not employing the presented first optimal solution and not optimizing the first optimal solution on the basis of the first desired level

Note that, in a case where the determination result indicates to employ the presented first optimal solution in the above (1), the solution search device 1 ends the processing at that stage.

In a case where the determination result indicates not to employ the presented first optimal solution but to optimize the first optimal solution on the basis of the first desired level in the above (2), the first optimization calculating unit 14 searches for a solution that is present around the first optimal solution on the solution space and is different from the first optimal solution on the basis of the determination result. The first optimization calculating unit 14 presents the found solution to the decision maker via the interface unit 20, and the decision maker determines whether or not to employ the presented solution. Hereinafter, the first optimization calculating unit 14 repeats the search for the solution until the presented solution is employed by the decision maker. Note that details of the solution search by the first optimization calculating unit 14 will be described in the fifth and sixth embodiments.

In a case where the determination result indicates that the presented first optimal solution is not employed, the first optimal solution is not optimized on the basis of the first desired level, and the first optimal solution is adjusted within the range of the frontier in the above (3), the first optimal solution adjusting unit 15 adjusts the first optimal solution within the range of the frontier on the basis of the determination result. Thus, the first optimal solution adjusting unit 15 calculates a second optimal solution different from the first optimal solution.

For example, when the solution space is a two-dimensional space, the first optimal solution adjusting unit 15 moves the first optimal solution calculated by the first optimal solution calculating unit 13 on a line indicating the frontier. Note that, at this time, the first optimal solution adjusting unit 15 receives an adjustment amount (movement amount) of the first optimal solution from the decision maker, and adjusts (moves) the first optimal solution on the line indicating the frontier on the basis of the received adjustment amount.

Further, for example, when the solution space is a three-dimensional space, the first optimal solution adjusting unit 15 moves the first optimal solution calculated by the first optimal solution calculating unit 13 on a plane indicating the frontier. Note that, at this time, the first optimal solution adjusting unit 15 receives the adjustment amount (movement amount) of the first optimal solution from the decision maker, and adjusts (moves) the first optimal solution on the plane indicating the frontier on the basis of the received adjustment amount.

The first optimal solution (that is, the second optimal solution) adjusted as described above is presented to the decision maker via the interface unit 20.

On the basis of the first optimal solution adjusted by the first optimal solution adjusting unit 15 (that is, the second optimal solution) and the ideal point indicating the optimal solution in all the objective functions among the plurality of objective functions, the second desired level calculating unit 16 calculates a second desired level different from the first desired level. The second desired level calculated here is presented to the decision maker via the interface unit 20.

The decision maker checks the presented second optimal solution and second desired level, and determines the following points. Then, the decision maker inputs the determination result to the solution search device 1 via the interface unit 20.
(4) Whether or not to employ the presented second optimal solution
(5) Whether or not to optimize the second optimal solution on the basis of the second desired level when not employing the presented second optimal solution
(6) Whether or not to start over from the setting of the first desired level when not employing the presented second optimal solution and not optimizing the second optimal solution on the basis of the second desired level

Note that, in a case where the determination result indicates to employ the presented second optimal solution in the above (4), the solution search device 1 ends the processing at that stage.

In a case where the determination result indicates not to employ the presented second optimal solution but to optimize the second optimal solution on the basis of the second desired level in the above (5), the second optimization calculating unit 17 searches for a solution that is present around the second optimal solution on the solution space and is different from the second optimal solution on the basis of the determination result. The second optimization calculating unit 17 presents the found solution to the decision maker via the interface unit 20, and the decision maker determines whether or not to employ the presented solution. Hereinafter, the second optimization calculating unit 17 repeats the search for the solution until the presented solution is employed by the decision maker. Note that details of the solution search by the second optimization calculating unit 17 will be described in the fifth and sixth embodiments.

Note that, in the above (6), in a case where the determination result indicates that the presented second optimal solution is not employed, the second optimal solution is not optimized on the basis of the second desired level, and the setting of the first desired level is not started over, the first optimal solution adjusting unit 15 adjusts (readjusts) the second optimal solution within the range of the frontier on the basis of the determination result. Thus, the first optimal solution adjusting unit 15 calculates a new second optimal solution different from the previously calculated second optimal solution. Note that, at this time, the first optimal solution adjusting unit 15 receives the adjustment amount (movement amount) from the decision maker again, and adjusts (moves) the second optimal solution within the range of the frontier on the basis of the received adjustment amount.

Further, in the above (6), in a case where the determination result indicates that the presented second optimal solution is not employed, the second optimal solution is not optimized on the basis of the second desired level, and it is started over from the setting of the first desired level, the decision maker inputs a desired level different from the previously input first desired level to the solution search device 1 via the interface unit 20 as a new first desired level. The desired level/ideal point setting unit 12 receives the new first desired level input by the decision maker via the interface unit 20 and sets the received new first desired level in the solution space. Hereinafter, similarly to the above, the first optimal solution based on the new first desired level is recalculated by the first optimal solution calculating unit 13.

The determination unit 18 determines what kind of contents the respective determination results input by the decision maker are.

The interface unit 20 implements an interface function for a decision maker who is a user. The interface unit 20 includes an input unit 21 including, for example, a keyboard, a mouse, and the like, and a display unit 22 including a display and the like.

The display control unit 23 causes the display unit 22 to display a screen indicated by the data generated by the screen generating unit 24.

The screen generating unit 24 generates data indicating a predetermined screen for the decision maker to input the ideal point, the first desired level, the adjustment amount, and the like, and to confirm the first optimal solution, the second optimal solution, and the like.

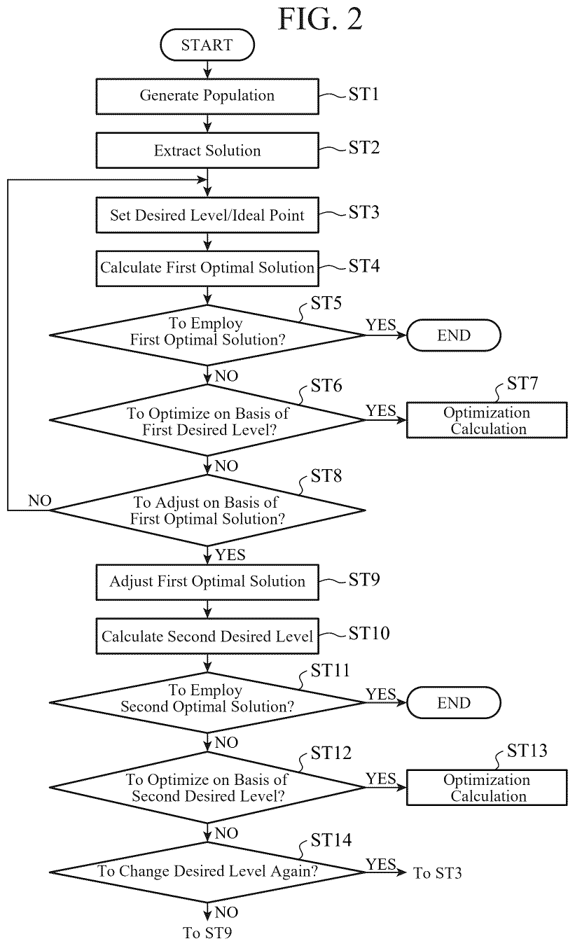

Next, an operation example of the solution search device 1 according to the first embodiment will be described with reference to a flowchart illustrated in FIG. 2.

Note that, in the following description, in order to simplify the description, a case where an optimal solution is calculated by the solution search device 1 in a multi-objective optimization problem having two objective functions will be described as an example. Further, in the following description, a case where the solution extracting unit 11 extracts a Pareto frontier as a frontier using a known optimization algorithm such as the above-described NSGA-II will be described as an example.

First, the population generating unit 10 generates a set of solutions (population) in a multi-objective optimization problem that optimizes two objective functions, using the above-described optimization algorithm (step ST1).

Next, the solution extracting unit 11 extracts the Pareto frontier from the set of solutions generated by the population generating unit 10 using the above-described optimization algorithm (step ST2).

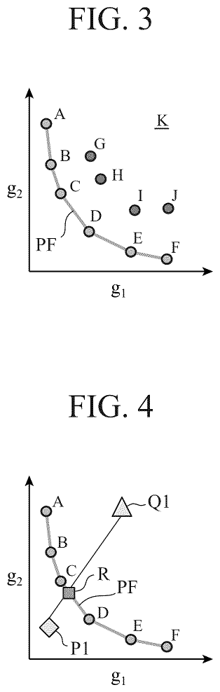

Here, an example of extraction of the Pareto frontier by the solution extracting unit 11 is illustrated in FIG. 3. In FIG. 3, the horizontal axis represents a first objective function (g1), and the vertical axis represents a second objective function (g2). In this case, the solution space K is a two-dimensional space.

Further, in FIG. 3, points A to J indicate a set (population) of solutions generated by the population generating unit 10, and each of the points A to F indicates a Pareto solution. Then, in FIG. 3, a line PF connecting points A to F indicates a Pareto frontier (set of Pareto solutions). Note that points G to J indicate a set (population) of solutions generated by the population generating unit 10 that is not a Pareto solution. Note that, in the following description, for convenience of description, each of the points A to F which are Pareto solutions is also referred to as a “solution on the Pareto frontier”.

Next, the decision maker inputs the ideal point and the first desired level to the solution search device 1 via the interface unit 20. The desired level/ideal point setting unit 12 receives the ideal point and the first desired level input by the decision maker via the interface unit 20, and sets the received ideal point and first desired level on the solution space K (step ST3).

Next, the first optimal solution calculating unit 13 calculates a first optimal solution by using the ideal point and the first desired level set by the desired level/ideal point setting unit 12 and the Pareto frontier extracted by the solution extracting unit 11 (step ST4).

Here, an example of calculation of the first optimal solution by the first optimal solution calculating unit 13 is illustrated in FIG. 4. In FIG. 4, a point P1 indicates an ideal point, a point Q1 indicates a first desired level, and a point R indicates a first optimal solution.

For example, the first optimal solution calculating unit 13 specifies an intersection between a straight line connecting the ideal point P1 set by the desired level/ideal point setting unit 12 and the first desired level Q1 and the line PF indicating the Pareto frontier extracted by the solution extracting unit 11, and calculates the specified intersection as a first optimal solution R. The first optimal solution R is a solution on the Pareto frontier. The first optimal solution R calculated here is presented to the decision maker via the interface unit 20.

Next, the decision maker checks the presented first optimal solution R, determines the points (1) to (3) described above, and inputs the determination result to the solution search device 1 via the interface unit 20.

Next, the determination unit 18 determines whether or not the determination result indicates to employ the presented first optimal solution R in the above (1) (step ST5). As a result, when it is determined that the determination result indicates to employ the presented first optimal solution R in the above (1) (step ST5; YES), the processing ends. On the other hand, when it is determined that the determination result does not indicate to employ the presented first optimal solution R in the above (1) (step ST5; NO), the processing proceeds to step ST6.

In step ST6, the determination unit 18 determines whether or not the determination result indicates to optimize the first optimal solution R on the basis of the first desired level Q1 in the above (2) (step ST6). As a result, when it is determined that the determination result indicates to optimize the first optimal solution R on the basis of the first desired level Q1 in the above (2) (step ST6; YES), the processing proceeds to step ST7. On the other hand, when it is determined that the determination result does not indicate to optimize the first optimal solution R on the basis of the first desired level Q1 in the above (2) (step ST6; NO), the processing proceeds to step ST8.

In step ST7, the first optimization calculating unit 14 searches for a solution that is present around the first optimal solution R on the solution space K and is different from the first optimal solution R. The first optimization calculating unit 14 presents the found solution to the decision maker via the interface unit 20, and the decision maker determines whether or not to employ the presented solution. Hereinafter, the first optimization calculating unit 14 repeats the search for the solution until the presented solution is employed by the decision maker. Note that, when the presented solution is employed by the decision maker, the solution search device 1 ends the processing.

In step ST8, the determination unit 18 determines whether or not the determination result indicates to adjust the first optimal solution R within the range of the Pareto frontier in the above (3) (step ST8).

As a result, when it is determined that the determination result does not indicate to adjust the first optimal solution R within the range of the Pareto frontier in the above (3) (step ST8; NO), the desired level/ideal point setting unit 12 prompts the decision maker to reinput the first desired level Q1 via the interface unit 20. In response to this, the decision maker reinputs the first desired level Q1 to the solution search device 1 via the interface unit 20. Thereafter, the processing returns to step ST3, and the desired level/ideal point setting unit 12 receives the first desired level Q1 reinput by the decision maker via the interface unit 20 and sets the received first desired level Q1 on the solution space K. Hereinafter, the solution search device 1 performs the processing of step ST3 and subsequent steps.

On the other hand, when it is determined that the determination result indicates to adjust the first optimal solution R within the range of the Pareto frontier in the above (3) (step ST8; YES), the processing proceeds to step ST9.

In step ST9, the first optimal solution adjusting unit 15 adjusts the first optimal solution R within the range of the Pareto frontier (step ST9). For example, the first optimal solution adjusting unit 15 moves the first optimal solution R on the line PF indicating the frontier in the solution space K. Note that, at this time, the first optimal solution adjusting unit 15 receives the adjustment amount (movement amount) of the first optimal solution R from the decision maker, and moves the first optimal solution R on the line PF indicating the frontier on the basis of the received adjustment amount. Thus, the first optimal solution adjusting unit 15 calculates a second optimal solution different from the first optimal solution R. The first optimal solution (that is, the second optimal solution) adjusted as described above is presented to the decision maker via the interface unit 20.

Next, on the basis of the first optimal solution (that is, the second optimal solution) adjusted by the first optimal solution adjusting unit 15 and the ideal point P1, the second desired level calculating unit 16 calculates a second desired level different from the first desired level Q1 (step ST10). The second desired level calculated here is presented to the decision maker via the interface unit 20.

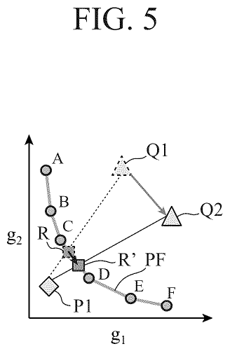

Here, an example of calculating the second optimal solution and the second desired level is illustrated in FIG. 5. In FIG. 5, a point P1 indicates an ideal point, a point Q1 indicates a first desired level, and a point R indicates a first optimal solution. Further, in FIG. 5, a point Q2 indicates a second desired level, and a point R′indicates a second optimal solution.

As illustrated in FIG. 5, the first optimal solution adjusting unit 15 adjusts the first optimal solution R by moving the first optimal solution R on the line PF indicating the Pareto frontier on the basis of the adjustment amount received from the decision maker. Thus, the first optimal solution adjusting unit 15 calculates a second optimal solution R′ different from the first optimal solution R.

Further, on the basis of the second optimal solution R′ calculated by the first optimal solution adjusting unit 15 and the ideal point P1, the second desired level calculating unit 16 calculates a second desired level Q2 that is a desired level different from the first desired level Q1. Details of a calculation example of the second optimal solution R′ and the second desired level Q2 will be described later.

Next, the decision maker checks the presented second optimal solution R′, determines the points (4) to (6) described above, and inputs the determination result to the solution search device 1 via the interface unit 20.

Next, the determination unit 18 determines whether or not the determination result indicates to employ the presented second optimal solution R′ in the above (4) (step ST11). As a result, when it is determined that the determination result indicates to employ the presented second optimal solution R′in the above (4) (step ST11; YES), the processing ends. On the other hand, when it is determined that the determination result does not indicate to employ the presented second optimal solution R′in the above (4) (step ST11; NO), the processing proceeds to step ST12.

In step ST12, the determination unit 18 determines whether or not the determination result indicates to optimize the second optimal solution R′ on the basis of the second desired level Q2 in the above (5) (step ST6). As a result, when it is determined that the determination result indicates to optimize the second optimal solution R′ on the basis of the second desired level Q2 in the above (5) (step ST12; YES), the processing proceeds to step ST13. On the other hand, when it is determined in the above (5) that the determination result does not indicate to optimize the second optimal solution R′ on the basis of the second desired level Q2 (step ST11; NO), the processing proceeds to step ST14.

In step ST13, the second optimization calculating unit 17 searches for a solution that is present around the second optimal solution R′ on the solution space K and is different from the second optimal solution R′. The second optimization calculating unit 17 presents the found solution to the decision maker via the interface unit 20, and the decision maker determines whether or not to employ the presented solution. Hereinafter, the second optimization calculating unit 17 repeats the search for the solution until the presented solution is employed by the decision maker. Note that, when the presented solution is employed by the decision maker, the solution search device 1 ends the processing.

In step ST14, the determination unit 18 determines whether or not the determination result indicates to start over from the setting of the first desired level Q1 in the above (6) (step ST14).

As a result, when it is determined in the above (6) that the determination result does not indicate to start over from the setting of the first desired level Q1 (step ST14; NO), the first optimal solution adjusting unit 15 prompts the decision maker to reinput the adjustment amount via the interface unit 20. In response to this, the decision maker reinputs the adjustment amount to the solution search device 1 via the interface unit 20. Thereafter, the processing returns to step ST9, and the first optimal solution adjusting unit 15 receives the adjustment amount reinput from the decision maker and moves the first optimal solution R on the line PF indicating the Pareto frontier on the basis of the received adjustment amount. Hereinafter, the solution search device 1 performs the processing of step ST9 and subsequent steps.

On the other hand, when it is determined in the above (6) that the determination result indicates to start over from the setting of the first desired level Q1 (step ST14; YES), the desired level/ideal point setting unit 12 prompts the decision maker to reinput the first desired level Q1 via the interface unit 20. In response to this, the decision maker reinputs the first desired level Q1 to the solution search device 1 via the interface unit 20. Thereafter, the processing returns to step ST3, and the desired level/ideal point setting unit 12 receives the first desired level Q1 reinput by the decision maker via the interface unit 20 and sets the received first desired level Q1 on the solution space K. Hereinafter, the solution search device 1 performs the processing of step ST3 and subsequent steps.

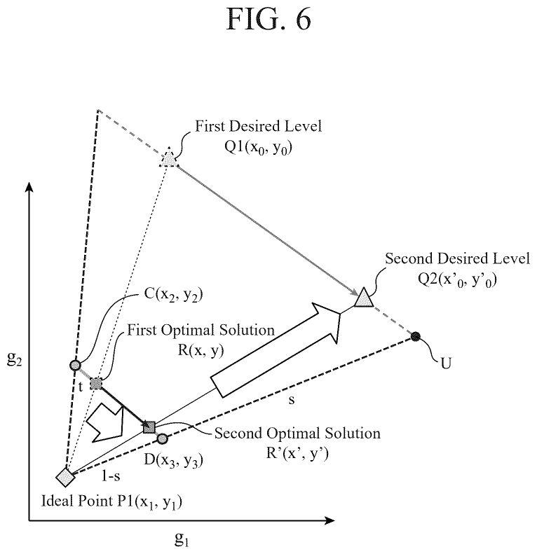

Next, details of a calculation example of the second optimal solution R′ and the second desired level Q2 will be described with reference to FIG. 6.

In FIG. 6, the horizontal axis represents the first objective function (g1), and the vertical axis represents the second objective function (g2). Further, in FIG. 6, a point P1 indicates an ideal point, a point Q1 indicates a first desired level, and a point R indicates a first optimal solution. Furthermore, in FIG. 6, a point Q2 indicates a second desired level, and a point R′indicates a second optimal solution.

Further, in FIG. 6, a point C and a point D indicate solutions on the Pareto frontier. Here, the points C and D are referred to as current solutions. In the example of FIG. 6, the first optimal solution R is present on a line segment connecting the current solution C and the current solution D.

Here, in FIG. 6, the coordinates of each point in the solution space K are defined as follows.
First optimal solution R: (x, y)
Second optimal solution R′: (x′, y′)
Ideal point P1: (x1, y1)
First desired level Q1: (x0, y0)

Second desired level Q2: (x′0, y′0)

Current solution C: (x2, y2)

Current solution D: (x3, y3)

Here, the first optimal solution adjusting unit 15 adjusts the first optimal solution R by moving the first optimal solution R on the line segment connecting the current solution C and the current solution D, and calculates a second optimal solution R′ different from the first optimal solution R. At this time, the decision maker inputs the adjustment amount of the first optimal solution R as a coefficient t.

For example, as illustrated in FIG. 6, the coefficient t corresponds to a ratio between the length of the line segment connecting the current solution C and the current solution D in the solution space and a length of a line segment connecting the current solution C (or the current solution D) and the second optimal solution R′. The decision maker inputs the coefficient t in the range of 0≤t≤1 via the interface unit 20. Then, the first optimal solution adjusting unit 15 calculates the second optimal solution R′ by the following Expression (1) using the input coefficient t.

$$( \begin{matrix}{x}^{′} \\ {y}^{′}\end{matrix} ) = ( \begin{matrix}{x}_{2} \\ {y}_{2}\end{matrix} ) + t ( \begin{matrix}{x}_{3} - {x}_{2} \\ {y}_{3} - {y}_{2}\end{matrix} ) \qquad ( 1 )$$

For example, when the coefficient t is 0, the second optimal solution R′is equal to the current solution C, but when the coefficient t increases from 0, the second optimal solution R′ approaches the current solution D on the line segment connecting the current solution C and the current solution D as the coefficient t increases. Then, when the coefficient t is 1, the second optimal solution R′is equal to the current solution D. Further, when the coefficient t is 0.5, the second optimal solution R′is located at a midpoint between the current solution C and the current solution D on the line segment connecting the current solution C and the current solution D.

After the second optimal solution R′is calculated as described above, the second desired level calculating unit 16 calculates the second desired level Q2, which is a desired level different from the first desired level Q1, on the basis of the calculated second optimal solution R′and the ideal point P1. For example, the second desired level calculating unit 16 calculates the second desired level Q2 by the following Expression (2).

$$( \begin{matrix}{x}_{0}^{′} \\ {y}_{0}^{′}\end{matrix} ) = ( \begin{matrix}{x}_{1} \\ {y}_{1}\end{matrix} ) + \frac{1}{1 - s} ( \begin{matrix}{x}^{′} - {x}_{1} \\ {y}^{′} - {y}_{1}\end{matrix} ) \qquad ( 2 )$$

Note that, in Expression (2), 1−s is a ratio of a length of a line segment connecting the ideal point P1 and the current solution D to the length of the line segment connecting the ideal point P1 and the point U. Note that the point U can be uniquely obtained as an intersection of a straight line connecting the ideal point P1 and the current solution D and a straight line passing through the first desired level Q1 and parallel to the line segment connecting the current solution C and the current solution D. That is, the second desired level calculating unit 16 calculates the second desired level Q2 by applying, among the ideal point P1, the second optimal solution R′, and the second desired level Q2, the relationship of the ratio of the line segment established among the ideal point P1, the current solution D, and the point U.

As described above, the first optimal solution adjusting unit 15 calculates the second optimal solution R′ by adjusting the first optimal solution R within the range of the Pareto frontier on the basis of the coefficient t that is the adjustment amount designated by the decision maker. Further, the second desired level calculating unit 16 calculates the second desired level Q2 on the basis of the second optimal solution R′ calculated by the first optimal solution adjusting unit 15 and the ideal point P1. At this time, the first optimal solution adjusting unit 15 calculates the second optimal solution R′ by adjusting the first optimal solution R within the range of the Pareto frontier, instead of changing the setting of the desired level from the first desired level to the second desired level and obtaining the second optimal solution on the basis of the changed second desired level as in the related method, so that the search efficiency of the second optimal solution R′is improved as compared with the related method. Therefore, the solution search device 1 can reduce the time necessary for obtaining the optimal solution that satisfies the decision maker as compared with the related art.

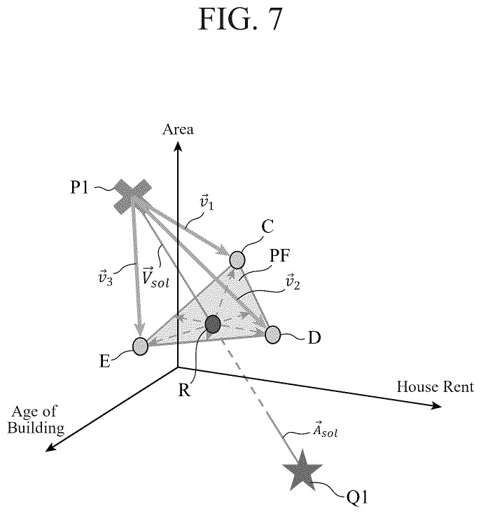

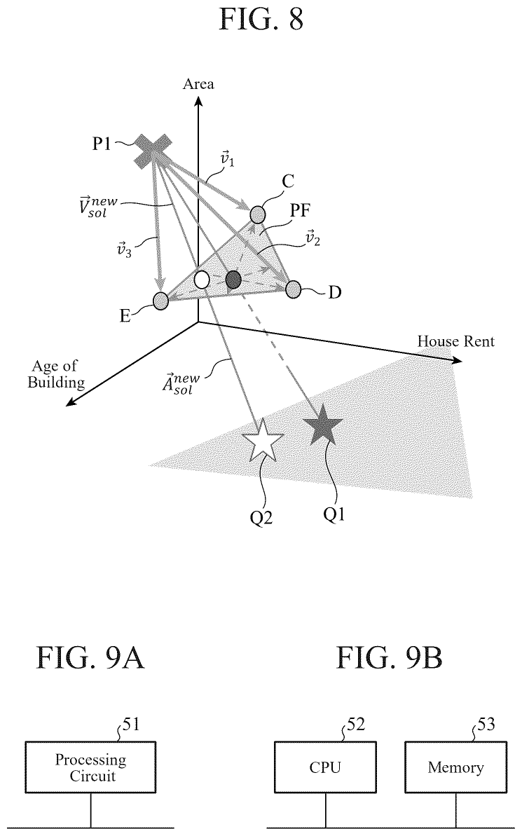

Next, an example in which the solution space K is a three-dimensional space will be described with reference to FIGS. 7 and 8 for details of calculation examples of the first optimal solution R, the second optimal solution R′, and the second desired level Q2.

In FIGS. 7 and 8, the solution space K is a three-dimensional space. That is, there are three objective functions. Here, as an example, it is assumed that three objective functions are “age of building”, “area”, and “house rent”, and a multi-objective optimization problem intended to search for a rental property that optimizes these three objective functions will be described as an example. In FIG. 7, a point P1 indicates an ideal point, a point Q1 indicates a first desired level, and a point R indicates a first optimal solution. Further, in FIG. 7, a reference sign PF is a plane indicating the Pareto frontier, and points C to E indicate solutions (current solutions) on the Pareto frontier.

Further, in FIG. 7, v1 represents a vector from the ideal point P1 to the current solution C, v2 represents a vector from the ideal point P1 to the current solution D, and v3 represents a vector from the ideal point P1 to the current solution E. Furthermore, in FIG. 7, Vₛₒₗ represents a vector from the ideal point P1 to the first optimal solution R. At this time, Vₛₒₗ is also referred to as a first vector, and v1 to v3 are also referred to as a second vector.

Even when the solution space K is a three-dimensional space, the solution search device 1 basically operates similarly to the case where the solution space K is a two-dimensional space. For example, in the solution space K, the first optimal solution calculating unit 13 calculates, as a first optimal solution R, an intersection between a line connecting the ideal point P1 and the first desired level Q1 received by the desired level/ideal point setting unit 12 and the plane PF indicating the Pareto frontier.

At this time, the vector Vₛₒₗ from the ideal point P1 to the first optimal solution R can be expressed by the following expressions (3) and (4) by addition of v1, v2, and v3. Here, v1, v2, and v3 are linearly independent.

$${\vec{V}}_{sol} = α {\vec{v}}_{1} + β {\vec{v}}_{2} + γ {\vec{v}}_{3} \\ \qquad ( 3 )$$

$$1 = α + β + γ \qquad ( 4 )$$

At this time, Expressions (5) to (7) are obtained from Expressions (3) and (4).

$${V}_{sol x} = α {v}_{x 1} + β {v}_{x 2} + γ {v}_{x 3} \\ {V}_{sol y} = α {v}_{y 1} + β {v}_{y 2} + γ {v}_{y 3} \\ {V}_{sol z} = α {v}_{z 1} + β {v}_{z 2} + γ {v}_{z 3} \qquad ( 5 )$$

$$[ \begin{matrix}{V}_{sol} x \\ {V}_{sol y} \\ {V}_{sol} z \\ 1\end{matrix} ] = [ \begin{matrix}{v}_{x 1} & {v}_{x 2} & {v}_{x 3} \\ {v}_{y 1} & {v}_{y 2} & {v}_{y 3} \\ {v}_{z 1} & {v}_{z 2} & {v}_{z 3} \\ 1 & 1 & 1\end{matrix} ] [ \begin{matrix}α \\ β \\ γ\end{matrix} ] \\ {v}^{†} [ \begin{matrix}{V}_{sol} x \\ {V}_{sol y} \\ {V}_{sol} z \\ 1\end{matrix} ] = [ \begin{matrix}α \\ β \\ γ\end{matrix} ] \qquad ( 6 )$$

$${v}^{†} is pseudo - inverse matrix of [ \begin{matrix}{v}_{x 1} & {v}_{x 2} & {v}_{x 3} \\ {v}_{y 1} & {v}_{y 2} & {v}_{y 3} \\ {v}_{z 1} & {v}_{z 2} & {v}_{z 3} \\ 1 & 1 & 1\end{matrix} ] \qquad ( 7 )$$

Here, (α, β, γ) expressed by Expression (7) corresponds to the adjustment amount (coefficient t) in a case where the above-described solution space K is a two-dimensional space. That is, when the solution space K is a three-dimensional space, the decision maker inputs the adjustment amount of the first optimal solution R as a value of (α, β, γ). Then, the first optimal solution adjusting unit 15 adjusts the first optimal solution R on the plane PF by Expression (3) on the basis of the input (α, β, γ), and calculates a new Vₛₒₗ, that is, a second optimal solution R′.

Further, similarly to the case where the solution space K is a two-dimensional space, the second desired level calculating unit 16 calculates the second desired level Q2 that is a desired level different from the first desired level Q1 on the basis of the second optimal solution R′ calculated by the first optimal solution adjusting unit 15 and the ideal point P1. For example, the second desired level calculating unit 16 calculates the second desired level Q2 by the following Expression (8).

$${\vec{A}}_{sol}^{new} = \frac{\vert {\vec{A}}_{sol} \vert}{\vert {\vec{V}}_{sol} \vert} {\vec{V}}_{sol}^{new} \\ {\vec{A}}_{sol}^{new} is vector from ideal point P 1 to second desired level Q 2 , \\ \vert {\vec{A}}_{sol} \vert is absolute value of vector length from ideal point P 1 \\ to first desired level Q 1 , \\ \vert {\vec{V}}_{sol} \vert is absolute value of vector length from ideal point P 1 \\ to first optimal solution R , and \\ {\vec{V}}_{sol}^{new} is vector from ideal point P 1 to second optimal {R}^{′} . \qquad ( 8 )$$

That is, in the solution space K, the ratio between the distance from the ideal point P1 to the first desired level Q1 and the distance from the ideal point P1 to the first optimal solution R is determined, and thus the second desired level calculating unit 16 calculates the second desired level Q2 using the determined ratio and the distance from the ideal point P1 to the second optimal solution R′.

As described above, when the solution space K is a three-dimensional space, the first optimal solution adjusting unit 15 calculates the second optimal solution R′by adjusting the first optimal solution R within the range of the Pareto frontier on the basis of the above (α, β, γ) that is the adjustment amount designated by the decision maker.

Further, the second desired level calculating unit 16 calculates the second desired level Q2 on the basis of the second optimal solution R′ calculated by the first optimal solution adjusting unit 15 and the ideal point P1. Even in this case, the first optimal solution adjusting unit 15 calculates the second optimal solution R′ by adjusting the first optimal solution R within the range of the Pareto frontier, instead of changing the setting of the desired level from the first desired level to the second desired level and obtaining the second optimal solution on the basis of the changed second desired level as in the related method, so that the search efficiency of the second optimal solution R′is improved as compared with the related method. Therefore, it is possible to shorten the time necessary for obtaining the optimal solution that satisfies the decision maker as compared with the related art.

Next, a hardware configuration example of the solution search device 1 according to the first embodiment will be described with reference to FIG. 9. The functions of the population generating unit 10, the solution extracting unit 11, the desired level/ideal point setting unit 12, the first optimal solution calculating unit 13, the first optimization calculating unit 14, the first optimal solution adjusting unit 15, the second desired level calculating unit 16, the second optimization calculating unit 17, the determination unit 18, the display control unit 23, and the screen generating unit 24 in the solution search device 1 are implemented by a processing circuit. The processing circuit may be dedicated hardware as illustrated in FIG. 9A, or may be a central processing unit (CPU, which may also be referred to as a central processing device, a processing device, an arithmetic device, a microprocessor, a microcomputer, a processor, or a digital signal processor (DSP)) 52 that executes a program stored in a memory 53 as illustrated in FIG. 9B.

In a case where the processing circuit is dedicated hardware, the processing circuit 51 corresponds to, for example, a single circuit, a composite circuit, a programmed processor, a parallel programmed processor, an application specific integrated circuit (ASIC), a field programmable gate array (FPGA), or a combination thereof. The functions of the population generating unit 10, the solution extracting unit 11, the desired level/ideal point setting unit 12, the first optimal solution calculating unit 13, the first optimization calculating unit 14, the first optimal solution adjusting unit 15, the second desired level calculating unit 16, the second optimization calculating unit 17, the determination unit 18, the display control unit 23, and the screen generating unit 24 may be implemented by the processing circuit 51, or the functions of the respective units may be collectively implemented by the processing circuit 51.

When the processing circuit is the CPU 52, the functions of the population generating unit 10, the solution extracting unit 11, the desired level/ideal point setting unit 12, the first optimal solution calculating unit 13, the first optimization calculating unit 14, the first optimal solution adjusting unit 15, the second desired level calculating unit 16, the second optimization calculating unit 17, the determination unit 18, the display control unit 23, and the screen generating unit 24 are implemented by software, firmware, or a combination of software and firmware. The software and the firmware are described as programs and stored in the memory 53. The processing circuit implements the functions of the respective units by reading and executing the programs recorded in the memory 53. That is, the solution search device 1 includes a memory for storing a program that results in execution of each step illustrated in FIG. 2, for example, when executed by the processing circuit. Further, it can also be said that these programs cause a computer to execute procedures and methods of the population generating unit 10, the solution extracting unit 11, the desired level/ideal point setting unit 12, the first optimal solution calculating unit 13, the first optimization calculating unit 14, the first optimal solution adjusting unit 15, the second desired level calculating unit 16, the second optimization calculating unit 17, the determination unit 18, the display control unit 23, and the screen generating unit 24. Here, the memory 53 corresponds to, for example, a nonvolatile or volatile semiconductor memory such as a random access memory (RAM), a read only memory (ROM), a flash memory, an erasable programmable ROM (EPROM), or an electrically EPROM (EEPROM), a magnetic disk, a flexible disk, an optical disk, a compact disk, a mini disk, or a digital versatile disc (DVD).

Note that some of the functions of the population generating unit 10, the solution extracting unit 11, the desired level/ideal point setting unit 12, the first optimal solution calculating unit 13, the first optimization calculating unit 14, the first optimal solution adjusting unit 15, the second desired level calculating unit 16, the second optimization calculating unit 17, the determination unit 18, the display control unit 23, and the screen generating unit 24 may be implemented by dedicated hardware, and some may be implemented by software or firmware. For example, the functions of the population generating unit 10 can be implemented by a processing circuit as dedicated hardware, and the functions of the solution extracting unit 11, the desired level/ideal point setting unit 12, the first optimal solution calculating unit 13, the first optimization calculating unit 14, the first optimal solution adjusting unit 15, the second desired level calculating unit 16, the second optimization calculating unit 17, the determination unit 18, the display control unit 23, and the screen generating unit 24 can be implemented by the processing circuit reading and executing a program stored in the memory 53.

As described above, the processing circuit can implement the above-described functions by hardware, software, firmware, or a combination thereof.

Note that, in the above description, an example has been described in which the solution search device 1 includes the population generating unit 10 and the solution extracting unit 11, and the population generating unit 10 and the solution extracting unit 11 generate a population (set of solutions) and extract a frontier. However, the solution search device 1 is not limited thereto, and may acquire information of the frontier extracted in advance by an external device from the device and perform processing using the acquired information of the frontier. In this case, the population generating unit 10 and the solution extracting unit 11 may be omitted.

Further, in the above description, an example has been described in which the desired level/ideal point setting unit 12 receives the ideal point and the first desired level input by the decision maker via the interface unit 20 and sets the received ideal point and first desired level on the solution space. However, the desired level/ideal point setting unit 12 does not necessarily receive the ideal point and the first desired level from the decision maker. For example, the desired level/ideal point setting unit 12 may read the ideal point and the first desired level set in advance in the solution search device 1 and set them in the solution space.

Further, in the solution search device 1, the processes of the optimization of the first optimal solution R based on the first desired level Q1 (step ST7 in FIG. 2), the calculation of the second desired level Q2 (step ST10 in FIG. 2), and the optimization of the second optimal solution R′ based on the second desired level Q2 (step ST13 in FIG. 2) are not necessarily performed. In addition, in a case where these processes are omitted, in the solution search device 1, the first optimization calculating unit 14, the second desired level calculating unit 16, and the second optimization calculating unit 17 are not essential components, and may be omitted.

As described above, according to the first embodiment, the solution search device 1 includes the desired level/ideal point setting unit 12 to set the first desired level Q1 that is a target value for a plurality of objective functions in the multi-objective optimization problem, a first optimal solution calculating unit 13 to calculate a first optimal solution R using the first desired level Q1 set by the desired level/ideal point setting unit 12 and a frontier that is a solution set for optimizing the plurality of objective functions; and a first optimal solution adjusting unit 15 to receive an input of an adjustment amount for adjusting the first optimal solution R from a user when receiving an instruction not to employ the first optimal solution R calculated by the first optimal solution calculating unit 13 from the user, and adjust the first optimal solution R within the range of the frontier on the basis of the received adjustment amount. Thus, the solution search device 1 according to the first embodiment can reduce the time necessary for obtaining an optimal solution that satisfies the decision maker as compared with the related art.

Further, the first optimal solution adjusting unit 15 calculates a second optimal solution R′ different from the first optimal solution R by adjusting the first optimal solution R within the range of the frontier on the basis of the adjustment amount. Thus, the solution search device 1 according to the first embodiment can accurately calculate the second optimal solution R′.

Further, when the solution space in the multi-objective optimization problem is a two-dimensional space, the first optimal solution calculating unit 13 calculates, as a first optimal solution R, an intersection between a line connecting the first desired level Q1 set by the desired level/ideal point setting unit 12 and the ideal point P1 indicating an optimal solution in all objective functions among a plurality of objective functions and a line indicating a frontier in the solution space, and the first optimal solution adjusting unit 15 performs adjustment by moving the first optimal solution R calculated by the first optimal solution calculating unit 13 by the adjustment amount on the line indicating the frontier. Thus, the solution search device 1 according to the first embodiment can accurately calculate the first optimal solution R and the second optimal solution R′ when the solution space is a two-dimensional space.

Further, when the first optimal solution R is located between two current solutions that are solutions present on a line indicating the frontier, the adjustment amount is given by a ratio between a length of a line segment connecting the two current solutions and a length of a line segment connecting one of the two current solutions and the first optimal solution R′ after adjustment. Thus, the solution search device 1 according to the first embodiment can accurately calculate the second optimal solution R′ on the basis of the adjustment amount.

Further, when the solution space in the multi-objective optimization problem is a three-dimensional space, the first optimal solution calculating unit 13 calculates, as a first optimal solution R, an intersection between a line connecting the first desired level Q1 set by the desired level/ideal point setting unit 12 and the ideal point P1 indicating an optimal solution in all objective functions among a plurality of objective functions and a plane indicating a frontier in the solution space, and the first optimal solution adjusting unit 15 performs adjustment by moving the first optimal solution R calculated by the first optimal solution calculating unit 13 by the adjustment amount on the plane indicating the frontier. Thus, the solution search device 1 according to the first embodiment can accurately calculate the first optimal solution R and the second optimal solution R′ when the solution space is a three-dimensional space.

Further, when the first optimal solution R is located on a plane indicating the frontier and including three current solutions that are solutions included in the frontier, the adjustment amount is given by a coefficient to be multiplied by each of three second vectors from the ideal point P1 to each of the three current solutions when a first vector from the ideal point P1 to the first optimal solution R′ after adjustment is represented by a sum of the three second vectors. Thus, the solution search device 1 according to the first embodiment can accurately calculate the second optimal solution R′ on the basis of the adjustment amount.

Further, the solution search device 1 includes the second desired level calculating unit 16 to calculate the second desired level Q2 that is a desired level different from the first desired level Q1 on the basis of the first optimal solution R′ adjusted by the first optimal solution adjusting unit 15 and the ideal point P1 indicating an optimal solution in all objective functions among the plurality of objective functions. Thus, the solution search device 1 according to the first embodiment can accurately calculate the second desired level Q2 that is a desired level different from the first desired level Q1.

### Second Embodiment

In the first embodiment, the solution search device 1 that calculates the second optimal solution R′ different from the first optimal solution R by adjusting the first optimal solution R within the range of the frontier on the basis of the adjustment amount received from the decision maker has been described. In a second embodiment, a solution search device 1 having a GUI function for supporting input operation of an adjustment amount by a decision maker will be described.

A configuration example of the solution search device 1 according to the second embodiment is the same as the configuration example of the solution search device 1 according to the first embodiment illustrated in FIG. 1. Note that, in the second embodiment, the screen generating unit 24 generates data (hereinafter, also referred to as “screen data”) indicating a support screen for supporting the input operation of the adjustment amount by the decision maker. Further, the display control unit 23 causes the display unit 22 to display the support screen indicated by the screen data generated by the screen generating unit 24.

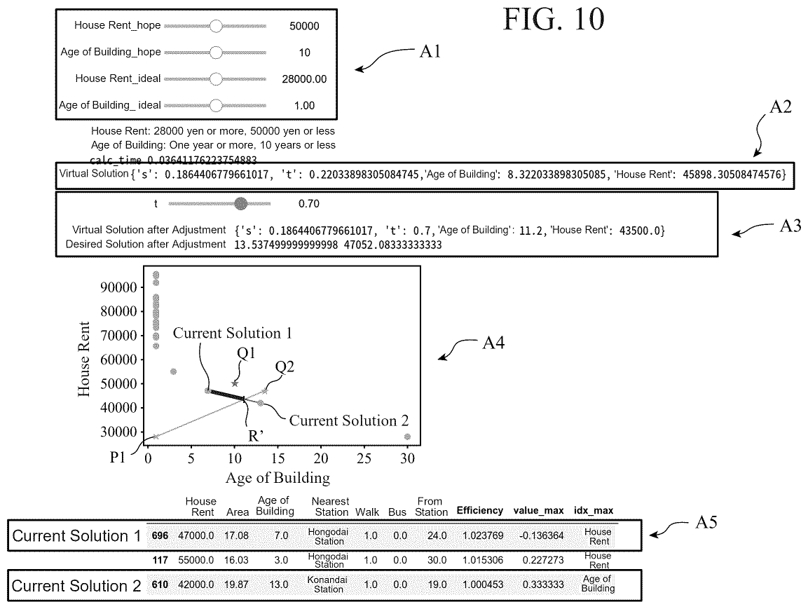

Here, an example of the support screen is illustrated in FIG. 10. Here, as an example, a case where the objective functions in the multi-objective optimization problem are two, that is, the house rent and the age of a building will be described as an example.

For example, as illustrated in FIG. 10, the support screen includes an input area A1 for ideal point and the like, a first optimal solution display area A2, an adjustment amount input area A3, a solution space display area A4, and a current solution display area A5.

The input area A1 for ideal point and the like is an area for the decision maker to input the ideal point P1 and the first desired level Q1 to the solution search device 1. In the input area A1 for ideal point and the like, the item “house rent_hope” indicates a first desired level for the house rent, and the item “age of building_hope” indicates a first desired level for the age of the building. Further, the item “House rent_ideal” indicates an ideal point for the house rent, and the item “Age of building_ideal” indicates an ideal point for the age of the building. Note that, in the example of FIG. 10, the first desired level for the house rent is “50000 (yen)”, the first desired level for the age of the building is “10 (year)”, the ideal point for the house rent is “28000.00 (yen)”, and the ideal point for the age of the building is “1.00 (year)”.

Further, an adjustment unit (here, a slide button) for adjusting the ideal point P1 and the first desired level Q1 is displayed adjacent to each item. The decision maker can arbitrarily adjust the ideal point P1 and the first desired level Q1 while continuously changing the ideal point P1 and the first desired level Q1 by appropriately operating the adjustment unit.

The first optimal solution display area A2 is an area in which the first optimal solution R (indicated as a “virtual solution” in the drawing) calculated by the first optimal solution calculating unit 13 is displayed.

The adjustment amount input area A3 is an area for the decision maker to input a coefficient t, which is the adjustment amount. Note that, in the example of FIG. 10, the coefficient t is “0.70”, but this value may be set in advance in the solution search device 1 as an initial value.

Further, an adjustment unit (here, a slide button) for adjusting the coefficient t is also displayed adjacent to the item. By appropriately operating the adjustment unit, the decision maker can arbitrarily adjust the coefficient t while continuously changing the value of the coefficient t. Note that, in the adjustment amount input area A3, the optimal solution after adjustment (that is, the second optimal solution R′) and the desired solution after adjustment (that is, the second desired level Q2) are also displayed.

The solution space display area A4 is an area for displaying the solution space. In the example of FIG. 10, a two-dimensional solution space defined by the age of a building on the horizontal axis and the house rent on the vertical axis is displayed. Note that, in the solution space displayed in the solution space display area A4, the Pareto frontier extracted by the solution extracting unit 11, the solution on the Pareto frontier, the ideal point P1, the first desired level Q1, the second desired level Q2, the first optimal solution R, the second optimal solution R′, and the like are displayed. The decision maker can intuitively grasp each value through the solution space display area A4.

The current solution display area A5 is an area for displaying the current solution. Here, among the solutions constituting the Pareto frontier, two solutions (current solutions 1 and 2) particularly close in distance from the first desired level Q1 are displayed as current solutions.

Next, a transition example of the support screen will be described. First, when the Pareto frontier is extracted by the solution extracting unit 11, the screen generating unit 24 generates screen data in a state where the Pareto frontier is displayed on the solution space in the solution space display area A4. The display control unit 23 causes the display unit 22 to display the support screen indicated by the generated screen data.

Next, the decision maker inputs the ideal point P1 and the first desired level Q1 from the input area A1 for ideal point and the like of the displayed support screen. In response to this input, the first optimal solution calculating unit 13 calculates the first optimal solution R. At this time, the screen generating unit 24 updates the previously generated screen data. The updated screen data is screen data in a state in which the first optimal solution R is displayed in the first optimal solution display area A2, the first optimal solution R is displayed on the solution space in the solution space display area A4, and the current solution is displayed in the current solution display area A5. Then, the display control unit 23 causes the display unit 22 to display the support screen indicated by the updated screen data.

Next, the decision maker determines whether or not to employ the first optimal solution R. If it is determined that the first optimal solution R is not employed and the optimization of the first optimal solution R based on the first desired level Q1 is not performed, the decision maker inputs the coefficient t as the adjustment amount from the adjustment amount input area A3.

In response to this input, the first optimal solution adjusting unit 15 adjusts the first optimal solution R within the range of the Pareto frontier on the basis of the coefficient t. Thus, the first optimal solution adjusting unit 15 calculates the second optimal solution R′. Further, the second desired level calculating unit 16 calculates the second desired level Q2.

At this time, the screen generating unit 24 updates the previously updated screen data again. The re-updated screen data is screen data in a state where the optimal solution after adjustment (that is, the second optimal solution R′) and the desired solution after adjustment (that is, the second desired level Q2) are displayed in the adjustment amount input area A3, and the second optimal solution R′ and the second desired level Q2 are displayed on the solution space in the solution space display area A4. The display control unit 23 causes the display unit 22 to display the support screen indicated by the re-updated screen data.

As described above, in the second embodiment, it is possible to generate and display the support screen for supporting the input operation of the adjustment amount by the decision maker. Thus, the decision maker can easily perform the input operation of the adjustment amount, and the operation burden is reduced. Further, the decision maker can easily input the ideal point P1 and the first desired level Q1 via the support screen.

Note that the configuration example of the support screen illustrated in FIG. 10 is merely an example. For example, the arrangement layout and the like of the areas A1 to A5 may be other than the above. In addition, in the above description, the example in which the adjustment unit displayed in the input area A1 for ideal point and the like and the adjustment amount input area A3 is configured by the slide button has been described, but the adjustment unit is not limited thereto, and may be configured by an element other than the slide button.

As described above, according to the second embodiment, the solution search device 1 includes the screen generating unit 24 to generate data indicating the support screen for supporting input of the adjustment amount by the decision maker, and the display control unit 23 to cause the display unit 22 to display the support screen indicated by the data generated by the screen generating unit 24. Thus, the solution search device 1 according to the second embodiment can reduce the operation burden on the decision maker in addition to the effects of the first embodiment.

Further, the support screen includes an adjustment amount input area A3 in which the decision maker is allowed to input the adjustment amount, and it is possible to display the first optimal solution R′ adjusted by the first optimal solution adjusting unit 15 on the basis of the input adjustment amount. Thus, the solution search device 1 according to the second embodiment can reduce the burden on the input operation of the adjustment amount by the decision maker. Further, the decision maker can easily confirm the adjusted first optimal solution R′.

Further, the support screen includes the input area A1 for ideal point and the like in which the decision maker is allowed to input the first desired level Q1 and the ideal point P1 indicating the optimal solution in all the objective functions among the plurality of objective functions. Thus, the solution search device 1 according to the second embodiment can reduce the burden on the input operation of the ideal point P1 and the first desired level Q1 by the decision maker.

### Third Embodiment

In the first embodiment, the case where the frontier is the Pareto frontier has been described as an example. In a third embodiment, a case where the frontier is an efficient frontier will be described as an example.

A configuration example of the solution search device 1 according to the third embodiment is the same as the configuration example of the solution search device 1 according to the first embodiment illustrated in FIG. 1. Note that, in the third embodiment, the solution extracting unit 11 extracts an efficient frontier using a data envelopment analysis (DEA) instead of the Pareto frontier.

The data envelopment analysis (DEA) is a tool for measuring management efficiency of a business entity (decision making unit (DMU)) having a multiple-input multiple-output system. It is assumed that production activities of the business entity perform some input (input) to obtain some revenue (output), and the conversion efficiency is evaluated on a one-dimensional scale of an efficiency value.

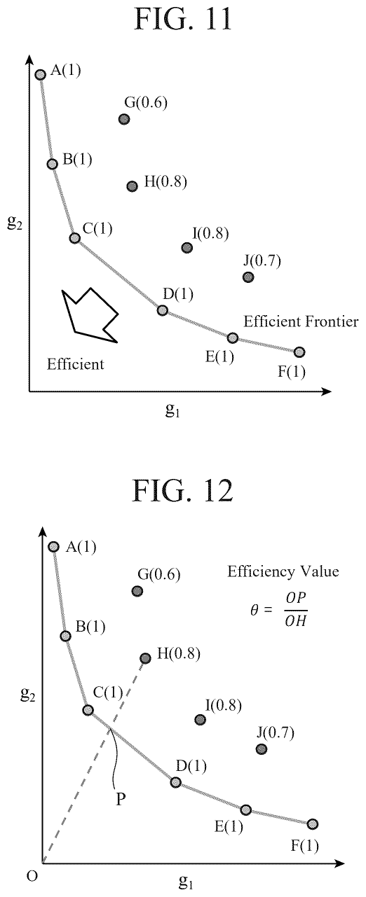

For example, as an example, a case of calculating efficiency values of eight business entities (A to J) having two objective functions g1 and g2 will be described with reference to FIG. 11. In FIG. 11, the horizontal axis represents the first objective function (g1), and the vertical axis represents the second objective function (g2).

In FIG. 11, it is indicated that the business entity located in the lower left (origin) direction performs an activity with higher productivity. In the data envelopment analysis (DEA), the efficient frontier in FIG. 11 is used as a Pareto optimal solution, and how far each business entity is from this efficient frontier is measured to evaluate each business entity.

In this case, a business entity on the frontier is determined to be performing efficient activities, and an evaluation value of 1 (=100%) is given. Conversely, a business entity not on the frontier is determined to be performing inefficient activities, and a number less than 1 is given as an evaluation value. Note that, in this case, the standard for evaluating each business entity is given not as one point (any one Pareto solution) but as a frontier, and thus it is possible to perform evaluation based on the characteristics of each business entity.

Note that, when extracting the efficient frontier, the solution extracting unit 11 calculates an efficiency value of each solution (each entity in the above example) present in the solution space. At this time, examples of a method of calculating the efficiency value include a Chames Cooper Rhodes (CCR) model and an extended CCR model.

The CCR model is a technique proposed by Chames Cooper Rhodes in 1978 for quantitatively evaluating efficiency values. Since this method is a known method, detailed description thereof is omitted, but in this method, the upper limit of the efficiency value is set to 1, and the efficient frontier is obtained.

For example, in the example of FIG. 12, the efficiency value 0 of the business entity H is calculated by θ=OP/OH. Then, on the basis of the following Expression (9), a business entity that maximizes θ (θ=1) is extracted, and the efficient frontier is obtained from the extraction result. Note that, in Expression (9), x represents an input, y represents an output, and u and v represent weights.

$$max {θ}_{o} := \frac{\sum {u}_{i}^{o} {y}_{i}^{o}}{\sum {v}_{i}^{o} {x}_{i}^{o}} \\ s . t . \\ \frac{\sum {u}_{i}^{o} {y}_{i}^{k}}{\sum {v}_{i}^{o} {x}_{i}^{k}} \leq 1 ( k = 1 , … , n ) \\ {v}_{i}^{o} \geq 0 ( i = 1 , … , m ) , {u}_{i}^{o} \geq 0 ( i = 1 , … , s ) \qquad ( 9 )$$

On the other hand, the extended CCR model is a model in which each business entity is excluded from the constraint in the CCR model and the efficiency value is allowed to exceed 1. Although the frontier plane serving as a reference for evaluation collapses, a business entity on the frontier in the CCR model can calculate one or more efficiency values.

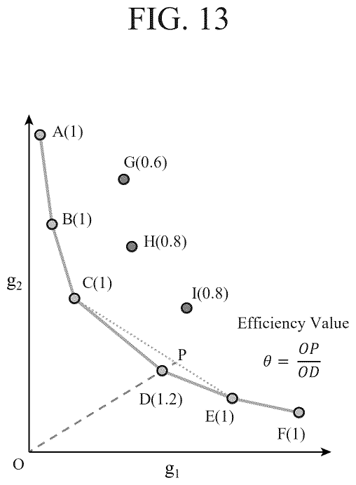

For example, in the example of FIG. 13, the efficiency value θ of the business entity D is calculated by θ=OP/OD. Then, a business entity that maximizes θ (θ may be equal to or more than 1) is extracted on the basis of the following Expression (10), and the efficient frontier is obtained from the extraction result.

$$max {θ}_{o} := \frac{\sum {u}_{i}^{o} {y}_{i}^{o}}{\sum {v}_{i}^{o} {x}_{i}^{o}} \\ s . t . \\ \frac{\sum {u}_{i}^{o} {y}_{i}^{k}}{\sum {v}_{i}^{o} {x}_{i}^{k}} \leq 1 ( k = 1 , … , n , k \neq o ) \\ {v}_{i}^{o} \geq 0 ( i = 1 , … , m ) , {u}_{i}^{o} \geq 0 ( i = 1 , … , s ) \qquad ( 10 )$$

Note that, here, as a method of calculating the efficiency value, the Chames Cooper Rhodes (CCR) model and the extended CCR model have been described, but the method of calculating the efficiency value is not limited thereto, and other methods may be used.

As described above, the solution extracting unit 11 according to the third embodiment extracts the efficient frontier using the data envelopment analysis (DEA) instead of the Pareto frontier. Thus, in the third embodiment, for example, a solution having an efficiency value equal to or more than 1 can be extracted as the frontier, and the number of solutions as the frontier can be reduced as compared with the first embodiment in which the Pareto frontier is extracted. Further, in the third embodiment, the number of frontier solutions can be reduced as compared with the first embodiment, so that the solution interpretation is also facilitated.

As described above, according to the third embodiment, the solution search device 1 includes the solution extracting unit 11 to extract the efficient frontier as the frontier from the solution set that is present in the solution space in the multi-objective optimization problem using the envelope analysis method, and the first optimal solution calculating unit 13 calculates the first optimal solution R using the first desired level Q1 set by the desired level/ideal point setting unit 12 and the efficient frontier extracted by the solution extracting unit 11. Thus, in addition to the effects of the first embodiment, the solution search device 1 according to the third embodiment can reduce the number of frontier solutions as compared with the first embodiment.

### Fourth Embodiment

In the first embodiment, an example has been described in which the second optimal solution R′ different from the first optimal solution R is calculated by adjusting the first optimal solution R within the range of the frontier on the basis of the adjustment amount received from the decision maker. In a fourth embodiment, an example will be described in which, when the decision maker is not satisfied with the second optimal solution R′ obtained by the above adjustment, a new desired level (second desired level) is presented to the decision maker, and the second optimal solution R′is calculated from the new desired level.

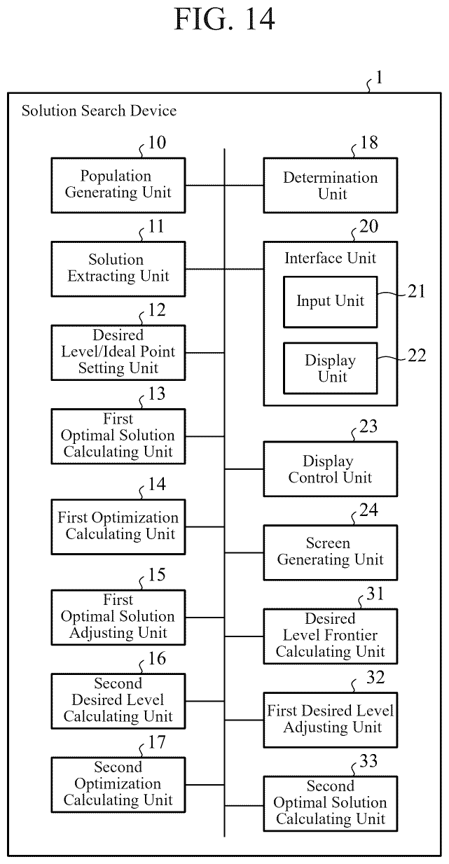

FIG. 14 is a diagram illustrating a configuration example of a solution search device 1 according to the fourth embodiment. The solution search device 1 according to the fourth embodiment is different from the solution search device 1 according to the first embodiment illustrated in FIG. 1 in that a desired level frontier calculating unit 31, a first desired level adjusting unit 32, and a second optimal solution calculating unit 33 are added. Since the other configurations of the solution search device 1 according to the fourth embodiment are the same as those of the solution search device 1 according to the first embodiment illustrated in FIG. 1, the same reference numerals are given and the description thereof will be omitted.

When receiving an instruction not to employ the first optimal solution (that is, the second optimal solution) R′ adjusted by the first optimal solution adjusting unit 15 from the decision maker, the desired level frontier calculating unit 31 calculates a desired level frontier, which is a set of candidates for the desired level including the first desired level Q1, using the frontier and the first desired level Q1 set by the desired level/ideal point setting unit 12.

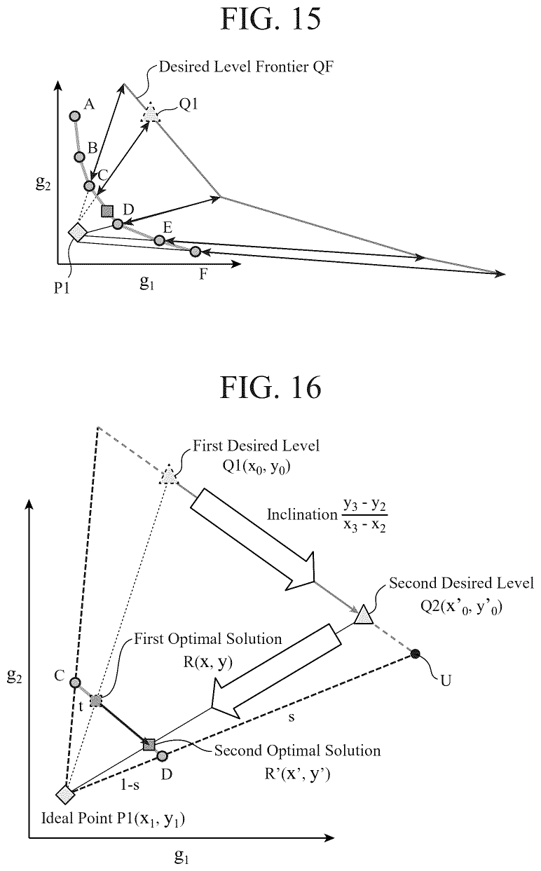

Here, an example of calculating the desired level frontier by the desired level frontier calculating unit 31 is illustrated in FIG. 15. For example, as illustrated in FIG. 15, when the solution space in the multi-objective optimization problem is a two-dimensional space, the desired level frontier calculating unit 31 calculates the desired level frontier indicated by a line obtained by enlarging a line indicating the Pareto frontier at a predetermined magnification.

For example, the desired level frontier calculating unit 31 draws a line that passes the first desired level Q1 and has a shape in which a line indicating the Pareto frontier is projected while being enlarged at a predetermined magnification in the right back direction (the direction in which the first desired level Q1 is present) on the solution space. A line QF drawn at this time is a line indicating a desired level frontier. At this time, the curvature of the bent portion in the line QF is substantially equal to the curvature of the bent portion in the line indicating the Pareto frontier.

The first desired level adjusting unit 32 receives an input of an adjustment amount for adjusting the first desired level Q1 from the decision maker, and calculates the second desired level Q2 by adjusting the first desired level Q1 within the range of the desired level frontier on the basis of the received adjustment amount.

The second optimal solution calculating unit 33 calculates a second optimal solution R′ different from the first optimal solution R by using the second desired level Q2 calculated by the first desired level adjusting unit 32 and the frontier.

Next, a calculation example of the second optimal solution R′ and the second desired level Q2 in the fourth embodiment will be described with reference to FIG. 16. In FIG. 16, the horizontal axis represents the first objective function (g1), and the vertical axis represents the second objective function (g2). Further, in FIG. 16, a point PI indicates an ideal point, a point Q1 indicates a first desired level, and a point R indicates a first optimal solution. Furthermore, in FIG. 16, a point Q2 indicates a second desired level, and a point R′ indicates a second optimal solution.

Further, in FIG. 16, a point C and a point D indicate solutions (current solutions) on the Pareto frontier. In the example of FIG. 16, the first optimal solution R is present on a line segment connecting the current solution C and the current solution D. Further, in FIG. 16, a line segment connecting the point Q1 and the point Q2 is a part of a line indicating a desired level frontier calculated by the desired level frontier calculating unit 31.

Here, in FIG. 16, the coordinates of each point in the solution space K are defined as follows.
First optimal solution R: (x, y)
Second optimal solution R′: (x′, y′)
Ideal point P1: (x1, y1)
First desired level Q1: (x0, y0)
Second desired level Q2: (x′0, y′0)
Current solution C: (x2, y2)
Current solution D: (x3, y3)

Here, the first desired level adjusting unit 32 adjusts the first desired level Q1 by moving the first desired level Q1 on a line segment indicating a desired level frontier, and calculates a second desired level Q2 different from the first desired level Q1. At this time, the decision maker inputs any one of the values (x, y) of the two objective functions that define the second desired level Q2 as the adjustment amount of the first desired level Q1 via the interface unit 20.

For example, the decision maker inputs, as the adjustment amount, a value of the x coordinate out of the x coordinate and the y coordinate that define the second desired level Q2. At this time, since the inclination of the line segment connecting the current solution C and the current solution D is equal to the inclination of the line segment connecting the point Q1 and the point Q2 (both are (y3−y2)/(x3−x2)), if the decision maker inputs only the value of the x-coordinate of the second desired level Q2, the first desired level adjusting unit 32 can obtain the value of the y-coordinate of the second desired level Q2 using the following Expression (11).

$${y}_{0}^{′} = {y}_{0} + \frac{{b}_{2}}{{a}_{2}} ( {x}_{0}^{′} - {x}_{0} ) \\ {b}_{2} = {y}_{3} - {y}_{2} \\ {a}_{2} = {x}_{3} - {x}_{2} \qquad ( 11 )$$

Alternatively, the decision maker may input the value of the y coordinate among the x coordinate and the y coordinate of the second desired level Q2 as the adjustment amount. In this case, the first desired level adjusting unit 32 can obtain the x coordinate of the second desired level Q2 using the following Expression (12).

$${x}_{0}^{′} = {x}_{0} + \frac{{a}_{2}}{{b}_{2}} ( {y}_{0}^{′} - {y}_{0} ) \qquad ( 12 )$$

In this manner, the decision maker only inputs, as the adjustment amount, the value of at least one of the x coordinate and the y coordinate defining the second desired level Q2, that is, the value of the objective function of at least one of the two objective functions, and the first desired level adjusting unit 32 can calculate the second desired level Q2. Therefore, the load on the input operation of the decision maker is reduced.

Then, when the second desired level Q2 is calculated as described above, the second optimal solution calculating unit 33 calculates the second optimal solution R′ by the following Expression (13).

$$( \begin{matrix}{x}^{′} \\ {y}^{′}\end{matrix} ) = ( \begin{matrix}{x}_{1} \\ {y}_{1}\end{matrix} ) + ( 1 - s ) ( \begin{matrix}{x}_{0}^{′} - {x}_{1} \\ {y}_{0}^{′} - {y}_{1}\end{matrix} ) \qquad ( 13 )$$

Note that, in Expression (13), 1−s is a ratio of the length of the line segment connecting the ideal point P1 and the current solution D to the length of the line segment connecting the ideal point P1 and the point U. Note that the point U can be uniquely obtained as an intersection of a straight line connecting the ideal point P1 and the current solution D and a line segment indicating a desired level frontier. That is, the second optimal solution calculating unit 33 calculates the second optimal solution R′ by applying the relationship of the ratio of the line segment established among the ideal point P1, the current solution D, and the point U between the ideal point P1, the second optimal solution R′, and the second desired level Q2.

As described above, in the fourth embodiment, the desired level frontier is generated, and the first desired level Q1 is adjusted within the range of the desired level frontier, whereby the second desired level Q2 is calculated. Then, the second optimal solution R′is calculated from the second desired level Q2. This means that the second optimal solution R′is calculated by an approach different from that of the first embodiment. Thus, even in a case where a satisfactory solution cannot be obtained even if the first optimal solution R is adjusted within the frontier range, the decision maker can obtain the second optimal solution R′ by another approach, that is, by adjusting the first desired level Q1 within the desired level frontier range. Further, at this time, the decision maker only needs to input at least one of the x coordinate and the y coordinate that define the second desired level Q2 as the adjustment amount of the first desired level Q1, so that the load on the input operation is also reduced.

Note that, in the above description, it has been assumed that the decision maker adjusts the first optimal solution R within the range of the frontier, but the decision maker is not limited thereto, and may generate the desired level frontier, adjust the first desired level Q1, and the like without adjusting the first optimal solution R within the range of the frontier.

As described above, according to the fourth embodiment, the solution search device 1 includes: the desired level frontier calculating unit 31 that calculates a desired level frontier, which is a set of desired level candidates including the first desired level Q1, by using the frontier and the first desired level Q1 set by the desired level/ideal point setting unit 12 when receiving an instruction not to employ the first optimal solution R′ adjusted by the first optimal solution adjusting unit 15 from a decision maker; the first desired level adjusting unit 32 that receives an input of an adjustment amount for adjusting the first desired level Q1 from the decision maker and adjusts the first desired level Q1 within the range of the desired level frontier on the basis of the received adjustment amount to calculate the second desired level Q2; and the second optimal solution calculating unit 33 that calculates a second optimal solution R′ different from the first optimal solution R using the second desired level Q2 calculated by the first desired level adjusting unit 32 and the frontier. Thus, the solution search device 1 according to the fourth embodiment can obtain the second desired level Q2 by adjusting the first desired level Q1 in addition to the effects of the first embodiment.

Further, a new optimal solution R′ can be calculated on the basis of the obtained second desired level Q2.

Further, when the solution space in the multi-objective optimization problem is a two-dimensional space, the desired level frontier calculating unit 31 calculates a desired level frontier indicated by a line QF obtained by enlarging the line indicating the frontier at a predetermined magnification. Thus, the solution search device 1 according to the fourth embodiment can easily generate the desired level frontier.

Further, the adjustment amount is given by a value of an objective function of any one of the values of the two objective functions that define the second desired level Q2. Thus, the solution search device 1 according to the fourth embodiment can reduce the load on the input operation of the decision maker.

### Fifth Embodiment

In a fifth embodiment, a specific method of optimization calculation by the first optimization calculating unit 14 and the second optimization calculating unit 17 will be described. A configuration example of the solution search device 1 according to the fifth embodiment is the same as the configuration example of the solution search device 1 according to the first embodiment illustrated in FIG. 1.

When the decision maker determines to optimize the first optimal solution R on the basis of the first desired level Q1, the first optimization calculating unit 14 searches for a solution that is present around the first optimal solution R on the solution space K and is different from the first optimal solution R. At this time, the first optimization calculating unit 14 determines a search area for a solution by converting the multi-objective optimization problem into a single-objective optimization problem on the basis of the ideal point P1, the first desired level Q1, and the first optimal solution R, and performs a focused search for a solution in the search area.

Similarly, when the decision maker determines to optimize the second optimal solution R′ on the basis of the second desired level Q2, the second optimization calculating unit 17 searches for a solution that is present around the second optimal solution R′ on the solution space K and is different from the second optimal solution R′. At this time, the second optimization calculating unit 17 determines a search area for the solution by converting the multi-objective optimization problem into a single-objective optimization problem on the basis of the ideal point P1, the second desired level Q2, and the second optimal solution R′, and performs a focused search of a solution in the search area.

Since the basic solution search methods by the first optimization calculating unit 14 and the second optimization calculating unit 17 are similar, here, a basic solution search method by the second optimization calculating unit 17 will be described as an example.

First, the second optimization calculating unit 17 sets an area (hereinafter, also referred to as a “reference area”) including the second optimal solution R′in the solution space K, and sets an area (hereinafter, also referred to as an “extended area”) on the solution space K obtained by extending the reference area to a predetermined range. Then, the second optimization calculating unit 17 randomly samples a plurality of solutions included in the extended area, and calculates an evaluation value of each obtained solution.

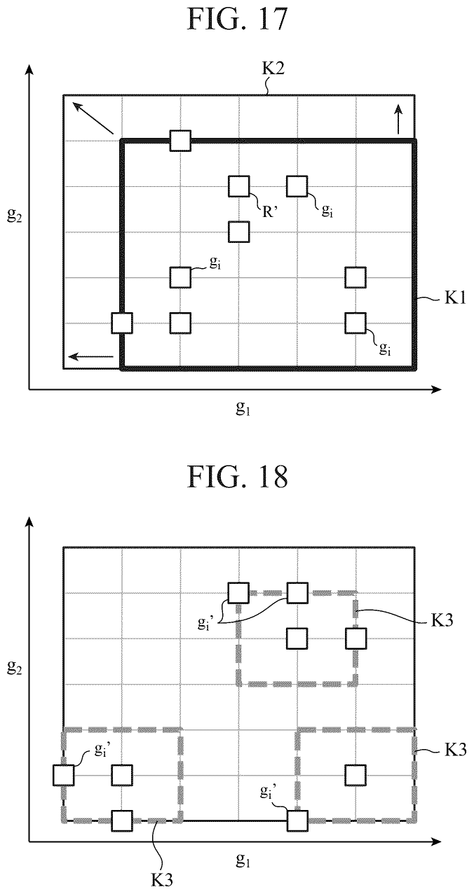

An example of this case is illustrated in FIG. 17. For example, in FIG. 17, reference sign R′ denotes the second optimal solution, reference sign K1 denotes the reference area, and reference sign K2 denotes the extended area. Further, reference sign gi denotes a sampled solution included in the extended area K2.

The second optimization calculating unit 17 calculates the evaluation value Vn, i of the sampled solution gi using, for example, the following Expression (14).

$${V}_{n , i} = \frac{{g}_{i} - {g}_{i}^{asp}}{{g}_{i}^{asp} - {g}_{i}^{ideal}} \\ {g}_{i}^{asp} is second desired level Q 2 , and {g}_{i}^{ideal} is ideal point P 1. \qquad ( 14 )$$

That is, the second optimization calculating unit 17 calculates the evaluation value Vn, i of each solution gi on the basis of how far each solution gi is from the second desired level Q2 on the solution space K. Here, a higher evaluation value Vn, i is calculated for a solution gi farther from the second desired level Q2 (a solution gi closer to the ideal point P1).

Then, the second optimization calculating unit 17 selects a predetermined number of solutions gi having higher evaluation values Vn, i. Then, as illustrated in FIG. 18, the second optimization calculating unit 17 sets a predetermined area on the solution space including each selected solution gi as a new search area K3, and randomly samples a plurality of solutions gi′ included in the search area K3. Then, the solution gi′ sampled from the search area K3 is presented to the decision maker via the interface unit 20, and the decision maker determines whether or not to employ each presented solution gi′.

As described above, in the fifth embodiment, the second optimization calculating unit 17 converts the multi-objective optimization problem into the single-objective optimization problem by calculating the evaluation value Vn, i based on the ideal point P1 and the second desired level Q2 for the solution gi sampled from the extended area K2 including the second optimal solution R′. Then, the second optimization calculating unit 17 selects a predetermined solution gi having a higher evaluation value Vn, i, sets a predetermined area on the solution space including each selected solution gi as a new search area K3, and intensively searches for a solution gi′ included in the search area K3. Thus, in the fifth embodiment, it is possible to intensively search for a solution close to the preference of the decision maker.

Note that a solution search method by the first optimization calculating unit 14 is basically similar to the search method by the second optimization calculating unit 17 described above. Note that, in the case of the first optimization calculating unit 14, in the above description, the second optimal solution R′ only needs to be replaced with the first optimal solution R, and the second desired level Q2 only needs to be replaced with the first desired level Q1.

As described above, according to the fifth embodiment, the solution search device 1 includes the second optimization calculating unit 17 to search for a solution that is present in a peripheral area of the adjusted first optimal solution R′in the solution space K in the multi-objective optimization problem when receiving an instruction not to employ the first optimal solution R′ adjusted by the first optimal solution adjusting unit 15 from the decision maker. Thus, the solution search device 1 according to the fifth embodiment can intensively search for a solution close to the preference of the decision maker in addition to the effects of the first embodiment.

Further, the second optimization calculating unit 17 calculates an evaluation value of a solution that is present in a peripheral area of the adjusted first optimal solution R′ on the basis of the second desired level Q2 and the ideal point P1, and further searches a periphery of a predetermined number of solutions of which the calculated evaluation values are higher. Thus, the solution search device 1 according to the fifth embodiment can convert the multi-objective optimization problem into the single-objective optimization problem by the evaluation value, and can intensively search for a solution close to the preference of the decision maker.

### Sixth Embodiment

In a sixth embodiment, another example of a specific method of optimization calculation by the first optimization calculating unit 14 and the second optimization calculating unit 17 will be described. A configuration example of the solution search device 1 according to the sixth embodiment is the same as the configuration example of the solution search device 1 according to the first embodiment illustrated in FIG. 1.

When the decision maker determines to optimize the first optimal solution R on the basis of the first desired level Q1, the first optimization calculating unit 14 searches for a solution that is present around the first optimal solution R on the solution space K and is different from the first optimal solution R. At this time, the first optimization calculating unit 14 determines a search area for a solution with the first desired level Q1 as a reference point, and performs intensive search for a solution in the search area.

Similarly, when the decision maker determines to optimize the second optimal solution R′ on the basis of the second desired level Q2, the second optimization calculating unit 17 searches for a solution that is present around the second optimal solution R′ on the solution space K and is different from the second optimal solution R′. At this time, the second optimization calculating unit 17 determines a search area for a solution with the second desired level Q2 as a reference point, and performs intensive search for a solution in the search area.

Since the basic solution search methods by the first optimization calculating unit 14 and the second optimization calculating unit 17 are similar, here, a basic solution search method by the second optimization calculating unit 17 will be described as an example.

First, the second optimization calculating unit 17 sets the second desired level Q2 as a reference point in the solution space. Then, the second optimization calculating unit 17 sets, as a new search area K4, an area that can include an area (reference area) including the second optimal solution R′in the solution space and has a distance from the reference point within a predetermined value, and intensively searches for a solution gi′ included in the search area K4. Then, the searched solution gi′ is presented to the decision maker via the interface unit 20, and the decision maker determines whether or not to employ each presented solution gi′.

As described above, in the sixth embodiment, the second optimization calculating unit 17 sets the second desired level Q2 as a reference point in the solution space, sets the search area K4 on the basis of the distance from the reference point, and intensively searches for the solution gi′ included in the search area K4. Thus, in the sixth embodiment, it is possible to intensively search for a solution close to the preference of the decision maker.

Note that a solution search method by the first optimization calculating unit 14 is basically similar to the search method by the second optimization calculating unit 17 described above. Note that, in the case of the first optimization calculating unit 14, in the above description, the second optimal solution R′ only needs to be replaced with the first optimal solution R, and the second desired level Q2 only needs to be replaced with the first desired level Q1.

As described above, according to the sixth embodiment, the second optimization calculating unit 17 searches for an area in which the distance in the solution space K from the reference point is within a predetermined value in the peripheral area of the adjusted first optimal solution R′ with the second desired level Q2 as the reference point. Thus, in the sixth embodiment, in addition to the effects of the first embodiment, it is possible to intensively search for a solution close to the preference of the decision maker.

Finally, an application example of the solution search device 1 according to the present disclosure will be described. The solution search device 1 according to the present disclosure can be applied to, for example, an air conditioning optimization system.

For example, the building manager changes the set temperature of the air conditioning system on the basis of the past power consumption data, and manages the daily power consumption so as not to exceed the target value of the power consumption. At this time, if the building manager suppresses the power consumption, there is a possibility that the comfort (=thermal comfort) of the office is lowered. Therefore, the administrator sets an appropriate desired level for the air conditioning optimization system in consideration of thermal comfort and allowable power consumption.

On the other hand, the air conditioning optimization system calculates an optimal solution based on a desired level set by the administrator in the multi-objective optimization problem in which the thermal comfort is set as the first objective function and the power consumption is set as the second objective function, and presents the optimal solution to the building manager. The solution search device 1 according to the present disclosure can be applied to an air conditioning optimization system used in such a situation.

Further, the solution search device 1 according to the present disclosure can be applied to, for example, a monitoring camera arrangement optimization system.

For example, monitoring cameras (hereinafter, also referred to as a “camera”) are installed everywhere such as in commercial facilities, in the premises of stations, and in town. In general, a camera is installed to detect and prevent a sign of an incident such as a crime, an accident, or a quarrel, or to check the presence or absence of an incident and grasp the situation of the place. Therefore, the camera needs to be arranged so as to surely capture a situation such as what has occurred at the time of occurrence of an incident or what is currently occurring. On the other hand, when the number of cameras increases, not only increases the cost, but also the burden on the maintenance and management of the cameras may increase.

Therefore, the administrator of the camera arrangement optimization system sets an appropriate desired level for the camera arrangement optimization system in consideration of a range to be intensively monitored (for example, a range that is likely to be a blind spot) and the number of allowable cameras.

On the other hand, in the multi-objective optimization problem in which the monitoring range by the camera is set as the first objective function and the number of cameras is set as the second objective function, the camera arrangement optimization system calculates an optimal solution based on a desired level set by the administrator and presents the optimal solution to the administrator. The solution search device 1 according to the present disclosure can be applied to a camera arrangement optimization system used in such a situation.

Note that, in the present disclosure, free combinations of the individual embodiments, modifications of any components of the individual embodiments, or omissions of any components in the individual embodiments are possible.

### INDUSTRIAL APPLICABILITY

The present disclosure can reduce the time necessary for obtaining an optimal solution that satisfies the decision maker as compared with the related art, and is suitable for use in a solution search device and a solution search method.

### REFERENCE SIGNS LIST

1: solution search device, 10: population generating unit, 11: solution extracting unit, 12: desired level/ideal point setting unit, 13: first optimal solution calculating unit, 14: first optimization calculating unit, 15: first optimal solution adjusting unit, 16: second desired level calculating unit, 17: second optimization calculating unit, 18: determination unit, 20: interface unit, 21: input unit, 22: display unit, 23: display control unit, 24: screen generating unit, 31: desired level frontier calculating unit, 32: first desired level adjusting unit, 33: second optimal solution calculating unit, 51: processing circuit, 52: CPU, 53: memory, A1: input area for ideal point, A2: first optimal solution display area, A3: adjustment amount input area, A4: solution space display area, A5: solution display area, C: current solution, D: current solution, g1: objective function, g2: objective function, gi: solution, gi′: solution, K: solution space, K2: extended area, K3: search area, K4: search area, P1: ideal point, PF: line or plane indicating frontier, Q1: first desired level, Q2: second desired level, R: first optimal solution, R′: second optimal solution

1. A solution search device comprising:
a processor; and
a memory storing a program, upon executed by the processor, to perform a process:
to set a first desired level that is a target value for a plurality of objective functions in a multi-objective optimization problem;
to calculate a first optimal solution using the first desired level and a frontier that is a solution set for optimizing the plurality of objective functions; and
to receive an input of an adjustment amount for adjusting the first optimal solution from a user when receiving an instruction not to employ the first optimal solution calculated from the user, and adjust the first optimal solution within a range of the frontier on a basis of the received adjustment amount.

2. The solution search device according to claim 1, wherein
the process
calculates a second optimal solution different from the first optimal solution by adjusting a first optimal solution within a range of the frontier on a basis of the adjustment amount.

3. The solution search device according to claim 1, wherein
when a solution space in the multi-objective optimization problem is a two-dimensional space,
the process
calculates, as a first optimal solution, an intersection between a line connecting the first desired level and an ideal point indicating an optimal solution in all objective functions among the plurality of objective functions and a line indicating the frontier in the solution space, and
the process
performs the adjustment by moving the first optimal solution calculated by the adjustment amount on the line indicating the frontier.

4. The solution search device according to claim 3, wherein
when the first optimal solution
is located between two current solutions that are solutions present on a line indicating the frontier,
the adjustment amount is given by a ratio between a length of a line segment connecting the two current solutions and a length of a line segment connecting one of the two current solutions and the first optimal solution after adjustment.

5. The solution search device according to claim 1, wherein
when a solution space in the multi-objective optimization problem is a three-dimensional space,
the process
calculates, as a first optimal solution,
an intersection between a line connecting the first desired level and an ideal point indicating an optimal solution in all objective functions among the plurality of objective functions and a plane indicating the frontier in the solution space, and
the process
performs the adjustment by moving the first optimal solution calculated by the adjustment amount on the plane indicating the frontier.

6. The solution search device according to claim 5, wherein
when the first optimal solution
is located on a plane indicating the frontier and including three current solutions that are solutions included in the frontier,
the adjustment amount
is given by a coefficient to be multiplied by each of three second vectors from the ideal point to each of three current solutions when a first vector from the ideal point to the first optimal solution after adjustment is expressed by a sum of the three second vectors.

7. The solution search device according to claim 1, the process further comprising:
to calculate a second desired level that is a desired level different from the first desired level on a basis of
the first optimal solution adjusted and
an ideal point indicating an optimal solution in all objective functions among the plurality of objective functions.

8. The solution search device according to claim 1, the process further comprising:
to generate data indicating a support screen for supporting input of the adjustment amount by the user; and
to display a support screen indicated by the data generated.

9. The solution search device according to claim 8, wherein
the support screen includes
an area in which the user is allowed to input the adjustment amount, and it is possible to display the first optimal solution adjusted on a basis of the input adjustment amount.

10. The solution search device according to claim 8, wherein
the support screen includes
an area in which the user is allowed to input the first desired level and an ideal point indicating an optimal solution in all objective functions among the plurality of objective functions.

11. The solution search device according to claim 1, the process further comprising:
to extract an efficient frontier as the frontier from a solution set that is present in a solution space in the multi-objective optimization problem using an envelope analysis method, wherein
the process calculates the first optimal solution using the first desired level and the efficient frontier extracted.

12. The solution search device according to claim 1, the process further comprising:
to calculate,
when an instruction not to employ the first optimal solution adjusted is received from a user, a desired level frontier that is a set of desired level candidates including the first desired level using the frontier and the first desired level;
to receive an input of an adjustment amount for adjusting the first desired level from the user and adjust the first desired level within a range of the desired level frontier on a basis of the received adjustment amount to calculate a second desired level; and
to calculate a second optimal solution different from the first optimal solution by using the second desired level calculated and the frontier.

13. The solution search device according to claim 12, wherein
when a solution space in the multi-objective optimization problem is a two-dimensional space,
the process
calculates the desired level frontier indicated by a line obtained by enlarging a line indicating the frontier at a predetermined magnification.

14. The solution search device according to claim 13, wherein
the adjustment amount
is given by a value of an objective function of any one of values of two objective functions that define the second desired level.

15. The solution search device according to claim 7, the process further comprising:
to search for a solution that is present in a peripheral area of the adjusted first optimal solution in the solution space in the multi-objective optimization problem
when receiving an instruction not to employ the first optimal solution adjusted from a user.

16. The solution search device according to claim 15, wherein
the process
calculates an evaluation value of a solution that is present in a peripheral area of the adjusted first optimal solution on a basis of the second desired level and an ideal point indicating an optimal solution in all objective functions among the plurality of objective functions, and further searches a periphery of a predetermined number of solutions of which the calculated evaluation value are higher.

17. The solution search device according to claim 15, wherein
the process
searches for an area in which a distance in a solution space from a reference point is within a predetermined value from a peripheral area of the adjusted first optimal solution using the second desired level as the reference point.

18. A solution search method performed by a solution search device, comprising:
setting a first desired level that is a target value for a plurality of objective functions in a multi-objective optimization problem;
calculating a first optimal solution using the first desired level and a frontier that is a solution set for optimizing the plurality of objective functions; and
receiving an input of an adjustment amount for adjusting the first optimal solution from a user when receiving an instruction not to employ the first optimal solution calculated from the user, and adjust the first optimal solution within a range of the frontier on a basis of the received adjustment amount.
